(19) United States
(12) Patent Application Publication
(10) Pub. No.: US 2023/0195241 A1
(43) Pub. Date: Jun. 22, 2023

(54) SYSTEMS AND METHODS FOR PROVIDING CONTROL OF AUGMENTED REALITY AND VIRTUAL REALITY CONTENT

(71) Applicant: Universal Electronics Inc., Scottsdale, AZ (US)

(72) Inventor: Arsham Hatambeiki, San Francisco, CA (US)

(21) Appl. No.: 17/552,399

(22) Filed: Dec. 16, 2021

(51) Int. Cl. G06F 3/0346; G09G 3/00; G06T 19/00; G08C 17/02

(52) U.S. Cl. CPC G06F 3/0346; G09G 3/002; G06T 19/006; G08C 17/02

(57) ABSTRACT

A controlling device is used to control a presentation of a one of a AR content or a VR content on a display device. A radio frequency connection between the controlling device and a signaling device located remotely from the controlling device is used to determine at least an orientation of the controlling device relative to the signaling device. The presentation of the one of the AR content or the VR content on the display device is then controlled as a function of the determined at least the orientation of the controlling device relative to the signaling device;

### BACKGROUND

Systems and methods for providing augmented reality and virtual reality are generally known in the art. For example, U.S. Publication No. US 2021/0072819, the disclosure of which is incorporated herein by reference in its entirety, describes that an information management component (IMC) of an augmented reality device (ARD) can monitor and detect user activities and conditions in an area in proximity to the ARD. Based on user activities and conditions, the IMC can determine augmented reality information that can enhance a user experience, performance of user activities, or security and safety of a user. The IMC can present, via an interface component of the ARD, the augmented reality information to the user. The augmented reality information can relate to user location; navigation by the user; tasks to be performed by the user; product assembly; maintenance work; system or product design or configuration; remote control of assembly, maintenance, design, or configuration; environmental and/or hazardous conditions; security, identification, and authentication of users; or training the user to perform tasks.

### SUMMARY

The following describes improved systems and methods for providing control of augmented reality (AR) and/or virtual reality (VR) content. Relative to known systems/methods, the subject systems and methods have the advantage of being less costly to realize while providing more precise location-based functionality, particularly when used to control the presentation of content in a home entertainment environment.

Generally, the described systems and method utilize Bluetooth low energy (BLE) and/or ultrawide band (UWB) communications to provide control of content based on precision positioning against a known host device. To provide one or more users with a big screen experience, as opposed to the conventional headset experience, AR and/or VR content is preferably presented to the one or more users through use of one or more display screens, such as one or more televisions, projectors, etc. When plural users are present in one or more locations, one or more of the users can control the content that is being displayed. Content control is particular performed by use of a handheld or wearable control device that is adapted to use BLE and/or UWB to determine positioning of the control device. In some examples, the BLE and/or UWB positioning can be expanded for accuracy using multi-axis, such as 6 or 9, sensor fusion, e.g., via use of accelerometer(s), gyroscope(s), compass(es), etc. In addition, the AR experience can be enabled through the use of one or more cameras associated with one or more of the display screens/home entertainment system, security cameras, and/or the like.

A better understanding of the objects, advantages, features, properties and relationships of the subject systems and methods will be obtained from the following detailed description and accompanying drawings which set forth illustrative examples which are indicative of the various ways in which the principles of the systems and methods may be employed.

### BRIEF DESCRIPTION OF THE DRAWINGS

For a better understanding of the systems and methods described hereinafter, reference may be had to preferred examples shown in the following drawings in which:

FIG. 1 illustrates an exemplary system employing a method for controlling content;

FIG. 2 illustrates a block diagram of components of an exemplary controlling device; and

FIG. 3 illustrates a block diagram of components of an exemplary signaling device.

### DETAILED DESCRIPTION

With reference to the figures, systems and methods for providing control of augmented reality (AR) and/or virtual reality (VR) content are now described. As will become apparent from the descriptions that follow, among other advantages the subject systems and methods have the advantage of allowing for control of content without a user having to move their head whilst wearing a visual headset.

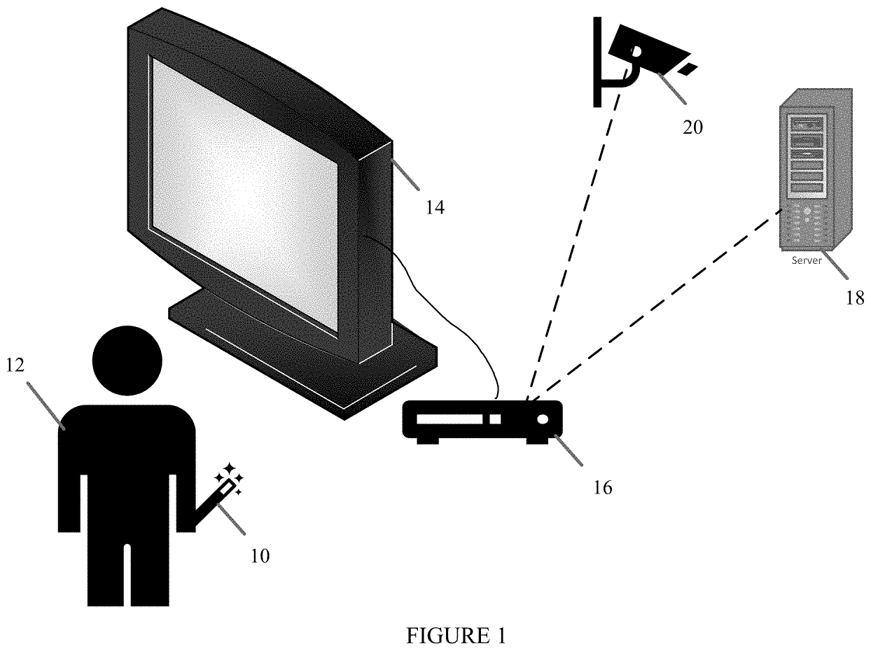

Turning to FIG. 1, an example system for controlling content includes at least one control device 10 for operation by a corresponding user 12, one or more display devices 14, such as televisions, a projector, etc., and one or more content delivery devices 16 coupled to the one or more display devices 14. The one or more content delivery devices 16 may be coupled to one or more remote servers 18, such as cloud servers, and the one or more remote servers 18 may be responsible for providing content to the one or more content delivery devices 16, updating content stored at the one or more content delivery devices 16, controlling how content is presented on the one or more display devices 12 via the content delivery devices 16, or the like. By way of example only, content delivery devices 16 can be in the form of VCRs, DVRs, DVD players, media streaming devices, cable converter boxes, game consoles, etc. A display device 14 and a content delivery device 16 can be integrated into a single unit as desired.

While not illustrated, it is to be understood that the system may have a plurality of users 12, the plurality of users 12 may each have a control device 10, the plurality of users 12 may each have access to their own respective display device(s) 14, and the users may be in different locations. Thus, the communicative linking of plural content delivery devices 16, either directly or through a remote server 18, allows for common content to be presented on one or more of the display devices 14 (in the same or in multiple locations) and allows for one or more of the users 12 (also in the same of in multiple locations) to control how that common content is being displayed on the respective display devices 12.

In instances where the example system is to be utilized to provide AR content, i.e., when the system is intended to present digital information in the context of a physical environment, the system may further include one or more cameras 20. The one or more cameras 20 would be coupled to the content delivery device 16 and the content delivery device 16 and/or a cloud server 18 would be responsible for incorporating/controlling the presentation of the AR content, based upon one or more conditions associated with the control device 10, into the physical environment imagery using one or more techniques that are known in the art. In the example illustrated in FIG. 1, the camera 20 is a security camera. It will be appreciated, however, the camera 20 can be an integral component of (or otherwise be a separate camera mounted to) the display device 14 or content delivery device 16, can be a camera 20 positioned remotely from the structure(s) in which the system(s) are deployed, and the like as desired for any particular purpose.

For use in controlling content that is displayed on a display device 14, the controlling device 10, e.g., a hand-held device such as a wireless, universal remote control, a cell phone, a wearable device such as a watch, etc., is adapted to communicate with a signaling device 104 that is associated with or integrated into the display device 14 and/or the content delivery device 16. Signals that are used to derive positioning information for use in content control will be transmitted from the signaling device 104 on a BLE network and/or a UWB network. Data communications to, from, or between the controlling device 10 and the display device 14/content delivery device 16 can also be transmitted using the same or additional BLE and/or UWB signals and/or by the use of communications transmitted on a separate RF and/or IR network, or the like as desired. Such data communications may include command transmissions from the controlling device 10 to the display device 14/content delivery device 16 for controlling functional operations of such devices (e.g., commands for turning on/off the devices, for controlling volume, etc.), transmissions from the controlling device to the content delivery device 16 for controlling the content that is to be displayed, transmissions to the controlling device 10 for configuring the controlling device 10 with command codeset(s) for controlling functional operations of the display device 14/content delivery device 16, transmission reception acknowledgements, etc. all as known to those of skill in the art.

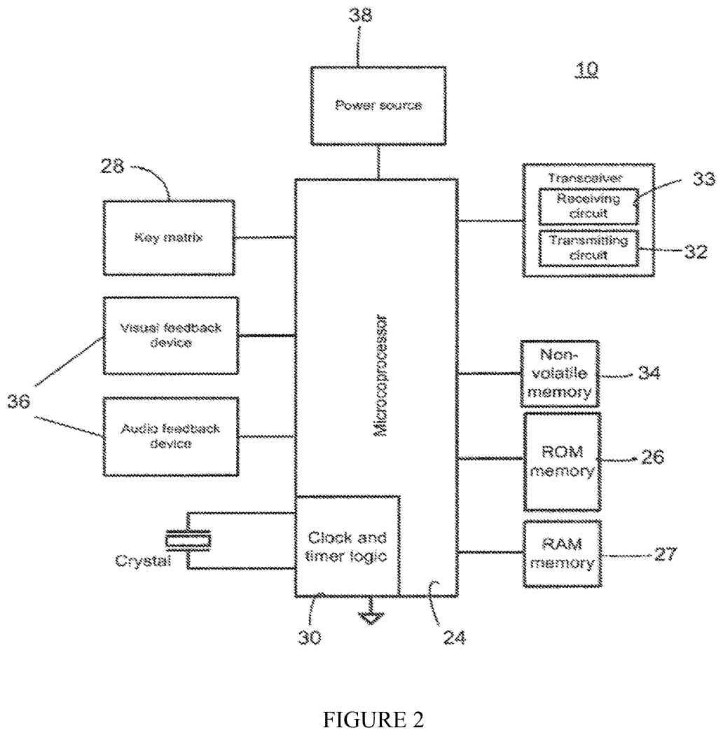

For use in communicating with a signaling device 104 (and possibly for transmitting data to and/or for receiving data from one or more devices as desired), the controlling device 10 may include, as needed for a particular application, a processor 24 coupled to a memory device (such as ROM memory 26, RAM memory 27, and a non-volatile memory 34), a key matrix 28 (e.g., physical buttons, a touch screen display, or a combination thereof), an internal clock and timer 30, transmission circuit(s) 32, receiver circuit(s) 33, and/or transceiver circuit(s) (e.g., BLE and/or UWB and possibly IR and/or RF), a means 36 to provide feedback to the user (e.g., LED, display, speaker, and/or the like), and a power supply 38 as generally illustrated in FIG. 2. As will be understood by those of skill in the art, the memory device may include executable instructions that are intended to be executed by the processor 24 to control the operation of the controlling device 10. In this manner, the processor 24 may be programmed to control the various electronic components within the controlling device 10, e.g., to monitor the power supply 38, to cause the transmission of signals, to determine the position/orientation of the controlling device 10 relative to the signaling device 104, etc.

The non-volatile read/write memory 34, for example an EEPROM, battery-backed up RAM, Smart Card, memory stick, or the like, may be provided to store setup data and parameters, to store algorithms for using signals received from the signaling device to derive positional data, and the like as necessary. Without limitation, the memory devices may take the form of any type of readable media, such as, for example, ROM, RAM, SRAM, FLASH, EEPROM, Smart Card, memory stick, a chip, a hard disk, a magnetic disk, and/or an optical disk. Still further, some of or all of the illustrated memory devices 26, 27, and 34 may be physically incorporated within the same IC chip as the microprocessor 24 (a so called “microcontroller”) and, as such, they are shown separately in FIG. 2 only for the sake of clarity.

It is to be understood that any signal processing could be performed on the controlling device 10 alone, at a cloud server 18 in communication with the controlling device 10, or a combination thereof. In addition, signal processing could be distributed amongst the various device within the local area network which includes the controlling device 10.

To identify controllable devices by type and make (and sometimes model) in order to configure remote control functionality of the controlling device 10 (should such functionality be included), the controlling device 10 can be adapted to obtain such information directly from such controllable devices. For example, BLE and/or UWB communications can be used to facilitate the controlling device 10 receiving from a controllable device appliance identifying data, such as a Device ID Profile. Once such appliance identifying data is received from the controllable appliances, the controlling device 10 can set itself up to control the operation of specific home appliances, e.g., to present a user interface for accepting input to cause the controlling device 10 to transmit one or more commands to one or more of the controllable devices using one or more protocols, such as IR, RF, BLE, etc, that will be recognized by an intended target appliance. As methods for using data to set-up/configure a controlling device are well-known, such methods need not be described in greater detail herein. Nevertheless, for additional information pertaining to controlling device setup, the reader may turn to U.S. Pat. Nos. 4,959,810, 5,614,906, and 6,225,938, which patents are incorporated herein by reference in their entirety. Meanwhile, a method for using appliance identifying data to link a user interface for a virtual equivalent of a controllable appliance to an intended target appliance may be found in U.S. Pat. No. 9,632,665, the disclosure of which is also incorporated herein by reference in its entirety.

To cause the controlling device 10 to perform an action, the controlling device 10 is adapted to be responsive to events, such as a sensed user interaction with the key matrix 28, receipt of a data or signal transmission, etc. In response to an event, appropriate instructions within the memory 26 may be executed. For example, when a command key is activated on the controlling device 10, the controlling device 10 may retrieve a command code corresponding to the activated command key from memory 26 and transmit the command code to a device in a format recognizable by the device. Similarly, when data is received from the local area network that is indicative of an appliance being added to and/or removed from an environment which includes the controlling device 10, that is indicative of the controlling device 10 being introduced into a new environment, etc., the controlling device 10 may automatically respond to such an event by configuring itself to communicate with the appliances within the environment as described above. Accordingly, the instructions within the memory 26 can be used to cause the transmission of command codes and/or data to the controllable appliances and to perform local operations, e.g., location-based features and functions, displaying information/data, favorite channel setup, macro button setup, function key relocation, etc. Examples of some of these local operations can be found in U.S. Pat. Nos. 5,481,256, 5,959,751, and 6,014,092, 6,225,938 and U.S. Application Serial Nos. 60/264,767, 09/905,423, 09/905,432, and 09/905,396, each of which is incorporated herein by reference in its entirety.

As discussed above, the controlling device 10 preferably includes programming such that the location and/or orientation of the controlling device 10 relative to the signaling device 104 may be determined. The location/orientation of the controlling device 10 is particularly determined by using one or more signals received by the controlling device 10 from the signaling device 104. Given a determination of location/orientation, the controlling device 10 may further include programming whereby the determined location/orientation information is provided to the content delivery device 16 and/or cloud server 18 for use by the content delivery device 16 and/or cloud server 18 in controlling the AR or VR content that a content delivery device 16 is causing to be displayed on a display device 14.

While the location/orientation determination may be performed in whole or in part at the controlling device 10, it is to be understood that the location/orientation determination may also be performed in whole or in part at a local and/or cloud-based server to which the controlling device 10 is coupled. In a further example, raw data associated with the received signals can be provided from the controlling device 10 to the signaling device 104, the content delivery device 16, and/or other devices coupled to the controlling device 10 and such devices may be responsible for determining the location/orientation information in whole or in part.

It will also be appreciated that determined location/orientation data may also be used to configure the controlling device 10 with various universal remote control functionalities, e.g., to cause the controlling device 10 to be provisioned with one or more command code sets, to setup controlling device states, favorite channel lineups, user interfaces, and/or macro commands, etc. The methods for such automated command set recall and/or generation are described more fully in commonly assigned, co-pending U.S. Provisional Application 60/517,283, entitled “Home Appliance Control System and Methods in a Networked Environment,” the disclosure of which is incorporated herein by reference in its entirety. Additional extended control functions may be implemented in conjunction with the current system and method, such as the ability to pause and resume appliance states across multiple control environments or zones, which is described more fully in commonly assigned, co-pending U.S. Application 60/517,737, entitled “System And Method For Saving And Recalling State Data For Media And Home Appliances,” the disclosure of which is also incorporated herein by reference in its entirety.

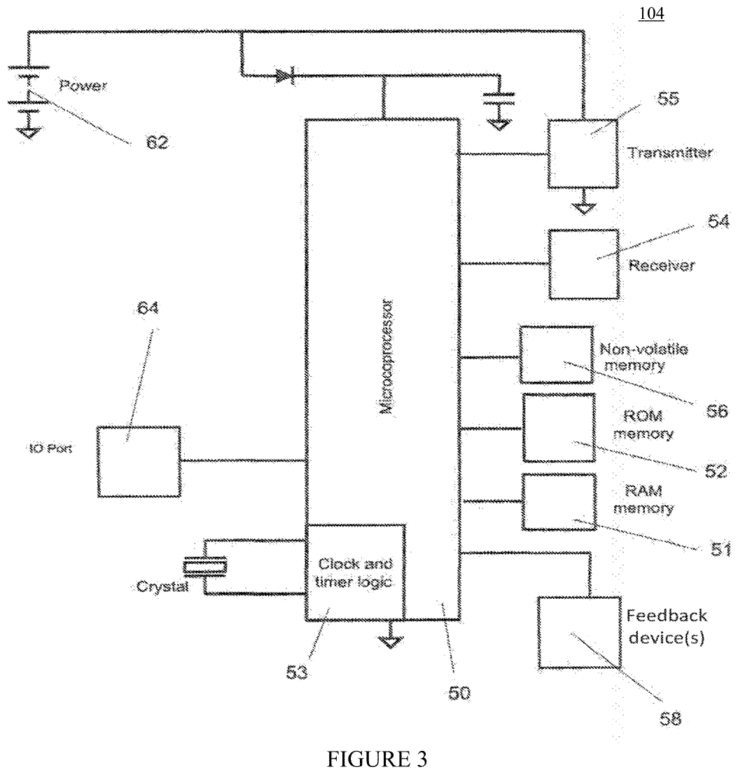

By way of further example, to facilitate at least the positioning and/or orientation determinations that are to be used to control the AR and/or VR content, the system and method includes one or more BLE and/or UWB enabled signaling devices 104. As noted previously, the signaling device(s) 104 may be a device separate and apart from the content delivery device 16 or may be integrated into the content delivery device 16 as desired. In any of these cases, the signaling device 104 may include, as needed for a particular application, a processor 50 coupled to a memory device (such as RAM memory 51, ROM memory 52, and/or non-volatile read/write memory 56), an internal clock and timer 53, receiver circuit(s) 54, transmission circuit(s) 55, and/or transceiver circuit(s) (e.g., BLE and IR and/or RF), a means 58 to provide feedback to the user (e.g., LED, display, speaker, and/or the like), a power supply 62, and communication means 64, (e.g., serial I/O port, Ethernet, 1394 firewire, wireless transceiver, etc.), as is generally illustrated in FIG. 3. The communication means 64 may be used to connect each signaling device 14 to a common home control unit (such as a control pod, server, HVAC, etc.) in order to enable communication and timing operations between all signaling devices 104.

The memory device may include executable instructions that are intended to be executed by the processor 50 to control the operation of the signaling device 104. In this manner, the processor 50 may be programmed to control the various electronic components within the signaling device 104, e.g., to monitor the power supply 62, to cause the transmission of signals to any further appliances, control devices etc. connected thereto, to provide audio or visual prompts to a user, etc. The non-volatile read/write memory 56, for example an EEPROM, battery-backed up RAM, Smart Card, memory stick, or the like, may also be provided to store setup data and parameters as necessary. While the memory 52 is illustrated and described as a ROM memory, memory 52 can also be comprised of any type of readable media, such as ROM, RAM, SRAM, FLASH, EEPROM, or the like. Preferably, the memory 56 is non-volatile or battery-backed such that data is not required to be reloaded after battery changes. In addition, the memories 51, 52 and/or 56 may take the form of a chip, a hard disk, a magnetic disk, and/or an optical disk. It will also be appreciated that in cases where signaling device capability is integrated into an appliance, some or all of the functional elements described above in conjunction with FIG. 3 may be combined with similar elements already present in the appliance for other purposes.

For transmitting and receiving information between controlling device 10 and the signaling device(s) 104, communications will be exchanged via use of BLE and/or via use of UWB communications. These communications are particularly used to derive the position/orientation information that is used to control the AR/VR content. While not required, additional communications, e.g., communications for providing control functions, may also be performed using an IR protocol such as XMP (described in co-pending U.S. patent application Ser. No. 10/431,930) and/or a further RF protocol, such as RFID. All that is required is that the signaling device 104 be able to decipher a signal received directly or indirectly from the controlling device 10 and/or that the controlling device 10 be able to decipher a signal received directly or indirectly from the signaling device 104.

For determining position/orientation information, it is contemplated that the controlling device 10 may support angle of arrival (“AoA”) direction finding functionality, angle of departure (“AoD”) direction finding functionality, and/or received signal strength indicator (RSSI) functionality to thereby allow the system to be used to determine the controlling device 10 position/orientation relative to the signaling device 104. Once the position/orientation of the controlling device 10 is determined, the position/orientation information may be provided to the content delivery device 16 and/or cloud server 18 whereupon the content delivery device 16 and/or cloud server 18 can determine/control the content that is to be presented in the display device 14, for example to cause the content to follow along with the controlling device 10 acting as a point device.

To support such functionality, it will be appreciated that the devices within the system are intended to communicate with each other will be provisioned with any hardware and software needed to support AoA, AoD, and RSSI.

The AoA method is used to determine a position of a receiving device relative to a RF transmitting device, e.g., a device having a transmitting BLE or UWB transceiver. The receiving device samples data from the signal packets while switching between each active antenna in an array. By doing so the receiving device detects the phase difference of the signal due to the difference in distance from each antenna in the array to the signal transmitting antenna. A positioning/orientation engine, on the receiving device and/or another device in communication with the receiving device, then uses the phase difference information to determine the angle from which the signals were received and hence the orientation of the transmitting device relative to the receiving device.

In the AoD method, a device with an antenna array sends a signal via each of its antennas. As each signal from the antennas in the array arrives at the receiver's single antenna, it is phase shifted from the previous signal due to the different distance the signal has travelled from the transmitter. A positioning/orientation engine, on the receiving device and/or another device in communication with the receiving device, then uses the data to determine the angle from which the signals were received and thereby the orientation of the transmitting device relative to the receiving device.

RSSI is an estimated measure of power level that a RF client device is receiving from an access point or router. At larger distances, the signal gets weaker and the wireless data rates get slower, leading to a lower overall data throughput.

It will be understood that, by utilizing a combination of AoA/AoD, and RSSI, the system can calculate the position/orientation of the controlling device 10 in the building with high accuracy. It will also be understood that the determined position/orientation can be expanded for accuracy using multi-axis, such as 6 or 9, sensor fusion, e.g., by using data captured via use of accelerometer(s), gyroscope(s), compass(es), etc. provided to the controlling device 10.

With respect to the systems and methods have been described herein, it is understood that, unless otherwise stated to the contrary, one or more functions may be integrated in a single physical device or a software module in a software product, or one or more functions may be implemented in separate physical devices or software modules, without departing from the scope and spirit of the present disclosure. It will also be appreciated that detailed discussion of the actual implementation of each module is not necessary for an enabling understanding of the invention. The actual implementation is well within the routine skill of a programmer and system engineer, given the disclosure herein of the system attributes, functionality, and inter-relationship of the various functional modules in the system. A person skilled in the art, applying ordinary skill can practice the present invention without undue experimentation. It will also be apparent to those skilled in the art that various modifications and improvements may be made without departing from the scope and spirit of the invention. Accordingly, it is to be understood that the invention is not to be limited by the specific illustrated embodiments.

All patents and applications for patent cited within this document are hereby incorporated by reference in their entirety.

1. A method for using a controlling device to control a movement of a one of a AR content or a VR content on a display device, comprising:
using by the controlling device a measurable characteristic of a radio frequency signal received from a signaling device located remotely from the controlling device on a radio frequency connection between the controlling device and the signaling device to determine at least an orientation of the controlling device relative to the signaling device; and
controlling by the controlling device the movement of the one of the AR content or the VR content on the display device as a function of the determined at least the orientation of the controlling device relative to the signaling device;
wherein the controlling device is separate from the display device.

2. The method as recited in claim 1, wherein the display device comprises a television.

3. The method as recited in claim 1, wherein the display device comprises a projector.

4. The method as recited in claim 2, wherein the controlling device comprises a hand-held, remote control device.

5. The method as recited in claim 3, wherein the controlling device comprises a hand-held, remote control device.

6. The method as recited in claim 1, wherein the radio frequency connection comprises a Bluetooth low-energy communications connection.

7. The method as recited in claim 1, wherein the radio frequency connection comprises an ultra-wide band communications connection.

8. The method as recited in claim 1, wherein the measurable characteristic of the radio frequency signal comprises an angle of arrival of the radio frequency signal and the method further comprises using an angle of arrival direction finding methodology to determine at least the orientation of the controlling device relative to the signaling device.

9. The method as recited in claim 1, wherein the measurable characteristic of the radio frequency signal comprises an angle of departure of the radio frequency signal and the method further comprises using an angle of departure direction finding methodology to determine at least the orientation of the controlling device relative to the signaling device.

10. The method as recited in claim 8, further comprising additionally using one or more of an accelerometer, a gyroscope, and a compass installed on the controlling device when determining at least the orientation of the controlling device relative to the signaling device.

11. The method as recited in claim 9, further comprising additionally using one or more of an accelerometer, a gyroscope, and a compass installed on the controlling device when determining at least the orientation of the controlling device relative to the signaling device.

12. A non-transitory, computer readable media having stored thereon instructions executable by a controlling device usable to control a movement of a one of a AR content or a VR content on a display device, the instructions, when executed by the controlling device, causing the controlling device to perform steps comprising:
using by the controlling device a measurable characteristic of a radio frequency signal received from a signaling device located remotely from the controlling device on a radio frequency connection between the controlling device and the signaling device to determine at least an orientation of the controlling device relative to the signaling device; and
using by the controlling device the determined at least the orientation of the controlling device relative to the signaling device to control the movement of the one of the AR content or the VR content on the display device;
wherein the controlling device is separate from the display device.

13. The non-transitory, computer readable media as recited in claim 12, wherein the display device comprises a television.

14. The non-transitory, computer readable media as recited in claim 12, wherein the display device comprises a projector.

15. The non-transitory, computer readable media as recited in claim 13, wherein the controlling device comprises a hand-held, remote control device.

16. The non-transitory, computer readable media as recited in claim 14, wherein the controlling device comprises a hand-held, remote control device.

17. The non-transitory, computer readable media as recited in claim 12, wherein the radio frequency connection comprises a Bluetooth low-energy communications connection.

18. The non-transitory, computer readable media as recited in claim 12, wherein the radio frequency connection comprises an ultra-wide band communications connection.

19. The non-transitory, computer readable media as recited in claim 12, wherein the measurable characteristic of the radio frequency signal comprises an angle of arrival of the radio frequency signal and the instructions cause the controlling device to use an angle of arrival direction finding methodology to determine at least the orientation of the controlling device relative to the signaling device.

20. The non-transitory, computer readable media as recited in claim 12, wherein the measurable characteristic of the radio frequency signal comprises an angle of arrival of the radio frequency signal and the instructions cause the controlling device to use an angle of departure direction finding methodology to determine at least the orientation of the controlling device relative to the signaling device.

21. The non-transitory, computer readable media as recited in claim 19, wherein the instructions cause the controlling device to additionally use one or more of an accelerometer, a gyroscope, and a compass installed on the controlling device when determining at least the orientation of the controlling device relative to the signaling device.

22. The non-transitory, computer readable media as recited in claim 20, wherein the instructions cause the controlling device to additionally use one or more of an accelerometer, a gyroscope, and a compass installed on the controlling device when determining at least the orientation of the controlling device relative to the signaling device.
